(19) United States
(12) Patent Application Publication
(10) Pub. No.: US 2021/0126723 A1
(43) Pub. Date: Apr. 29, 2021

(54) SMART SIGNAL LEVEL METER FOR ANTENNA INSTALLATION

(71) Applicant: Winegard Company, Burlington, IA (US)

(72) Inventors: Larry Edward Foster, Quincy, IL (US); Kevin Murphy, Palmyra, MO (US); Stacie Venghaus, Mt. Pleasant, IA (US)

(73) Assignee: Winegard Company, Burlington, IA (US)

(21) Appl. No.: 17/020,012

(22) Filed: Sep. 14, 2020

Related U.S. Application Data
(60) Provisional application No. 62/925,903, filed on Oct. 25, 2019.

(51) Int. Cl. H04B 17/318; H04B 17/11; H04W 16/18

(52) U.S. Cl. CPC H04B 17/318; H04W 16/18; H04B 17/11

(57) ABSTRACT

A signal level meter for use in installing an antenna that includes a wireless interface for communications with a portable electronic device hosting applications software to provide a remote user interface. The signal level meter is typically installed between the antenna and TV/STB. A tuner-demodulator demodulates the antenna signal, allows adjustable gain, and generates a signal level output. A wireless interface provides two-way communication (e.g., Bluetooth) between the signal level meter and the portable electronic device (e.g., smart phone) running applications software (or “app”). The app enables the user to remotely view information from the signal level meter regarding signal strength and signal source identification via a graphical user interface. This user interface also enables the user to remotely control operation of the signal level meter, including signal source selection (e.g., channel selection), amplifier gain and filter selection.

### RELATED APPLICATION

The present application is based on and claims priority to the Applicant's U.S. Provisional Patent Application 62/925,903, entitled “Smart Signal Level Meter for Antenna Installation,” filed on Oct. 25, 2019.

### BACKGROUND OF THE INVENTION

### Field of the Invention

The present invention relates generally to the field of signal level meters for antenna installation. More specifically, the present invention discloses a signal level meter having a wireless link to a smartphone running an app that can be used to remotely control operation of the signal level meter and assist in antenna installation.

### Statement of the Problem

Signal level meters have been employed for many years in conjunction with antennas, such as the applicant's U.S. Pat. No. 8,466,965 (Murphy et al.). A signal level meter (or SLM) typically provides a visual or audible indicia of the strength of the received signal output by the antenna to a TV or receiver. For example, this can be done by displaying a number or a bar graph. The signal level meter typically measures the signal strength in a selected frequency band (e.g., corresponding to a selected satellite, television channel or radio station). In this configuration, signal level meters are widely used during installation of an antenna to optimize its direction by maximizing signal strength from desired signal sources and minimizing unwanted interference. A similar process can be repeated for mobile antennas (e.g., antennas mounted on vehicles) each time the antenna is deployed at a new location.

During this installation or deployment process, the signal level meter should preferably be used to measure the signal strength at or near the TV or set-top box (STB). However, the antenna and TV are often remote from one another. For example, an antenna is often on the roof or in the attic of a house, while the television is located in the living room or family room. Similarly, a mobile antenna is often mounted externally to the roof of a vehicle, while the TV is located within the vehicle. This often creates a need for the installer to repeatedly move between these locations while installing an antenna to view the effect each antenna adjustment has on signal strength at the TV/STB. Moving back and forth between the antenna and TV can be time-consuming and potentially dangerous for the installer. Thus, a need exists for a signal level meter that allows the installer to remotely monitor the received signal strength while making adjustments to the antenna.

U.S. Pat. No. 6,216,266 (Eastman et al.) discloses a signal level meter that communicates signal quality information and commands with a remote control. The remote control enables the user to view parameters relating to the measured signal quality. However, the Eastman system does not include means for the remote control to adjust the gain, attenuation or filtering of the output signal to the TV/STB.

Similarly, the DVBFinder dongle and app can be used for setting up a satellite dish and receiver. This includes an Android app that can be installed on a conventional smartphone to communicate with a dongle plugged into the satellite receiver (or with a satellite receiver equipped with the dongle's functionality). The app shows the antenna azimuth, signal strength and quality. Here again, the app does not include means for adjusting the gain, attenuation or filtering of the output signal to the TV/STB.

The prior art in this general field also includes a number of universal remote control apps that enable a conventional smart phone to remotely control a TV, set-top box, cable box, digital video recorder (DVR), stereo or other components in a home entertainment system. These universal remote control apps are generally limited to the kinds of controls typically found on conventional remote controllers, such as volume adjustment, changing channels, power on/off, etc.

### Solution to the Problem

The present invention provides a signal level meter that enables an installer to remotely monitor and adjust the signal strength at the TV/STB by a wireless link to an app running on a smartphone or similar portable electronic device while installing an antenna.

### SUMMARY OF THE INVENTION

This invention provides a signal level meter for use in installing an antenna that includes a wireless interface for communications with a portable electronic device hosting applications software to provide a remote user interface. The signal level meter is typically installed between the antenna and TV/STB. A tuner-demodulator demodulates the antenna signal, allows adjustable gain, and generates a signal level output. A wireless interface (e.g., Bluetooth) provides two-way communication between the signal level meter and the portable electronic device (e.g., a smart phone) running applications software (or “app”). The app enables the user to remotely view information from the signal level meter regarding signal strength and signal source identification via a graphical user interface. This user interface also enables the user to remotely control operation of the signal level meter, including signal source selection (e.g., channel selection), amplifier gain and filter selection.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a simplified diagram of the antenna 10, signal level meter 20, smartphone 30 and TV/STB 18 during a typical installation.

FIG. 2 is a schematic block diagram of one possible embodiment of the signal level meter 20.

FIG. 3 is an example of a display by the app showing the signal strength and related information for a single signal source 15.

FIG. 4 is an example of a display by the app showing a summary of results from a scan of available signal sources 15.

FIG. 5 is an example of a display showing a listing of available signal sources 15 and their respective signal strengths resulting from a scan.

FIG. 6 is an example of a display showing a listing of available HDTV channels resulting from a scan.

FIG. 7 is an example of a display showing a map of available signal sources.

### DETAILED DESCRIPTION OF THE INVENTION

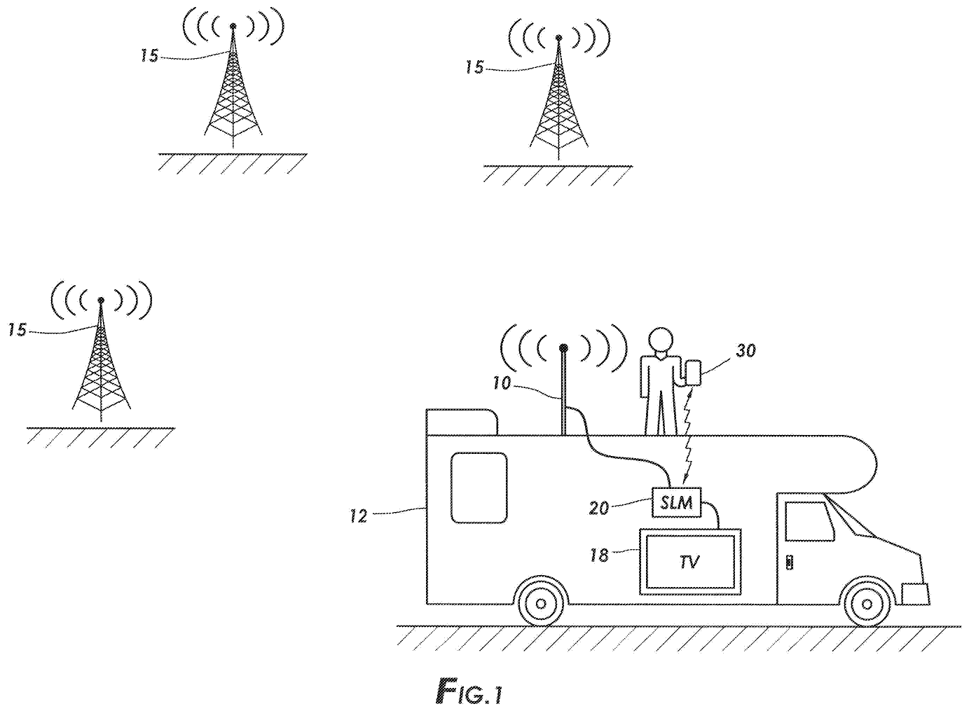

Turning to FIG. 1, a simplified diagram is shown of a typical antenna installation using the present signal level meter 20. The antenna 10 is usually mounted to the vehicle 12 or building at a location remote to the TV or set-top box (STB) 18 within the vehicle 12 or building. For example, many antennas 10 are mounted to the external of the vehicle 12, or to the roof of a building to increase the elevation of the antenna, minimize obstructions, and thereby improve signal reception from external signal sources 15, such as satellites or terrestrial radio or television stations. The signal level meter 20 communicates with, and is controlled by a portable electronic device 30 (e.g., a smartphone).

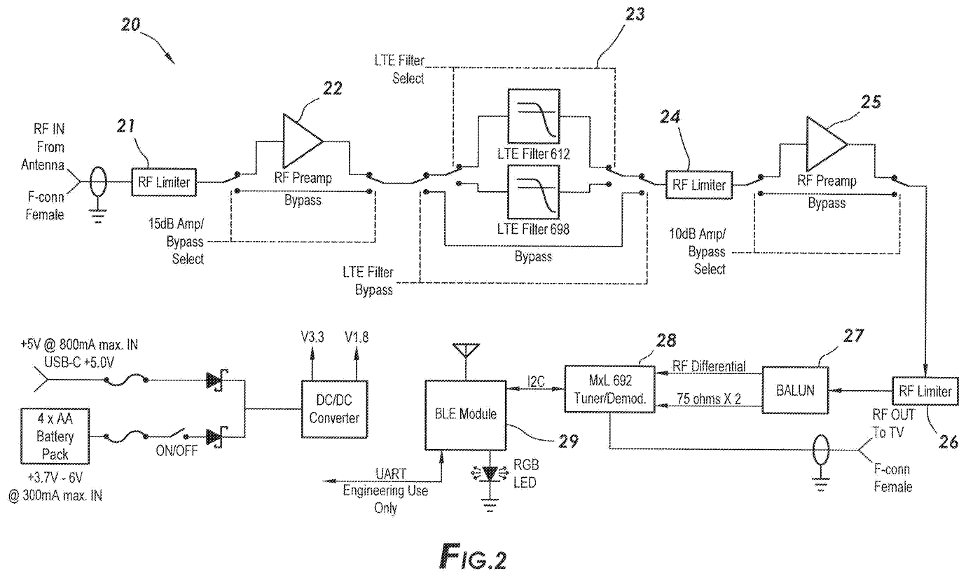

A block diagram of one embodiment of the signal level meter 20 is shown in FIG. 2. The signal level meter 20 is generally intended to be connected in series between the antenna 10 and TV/STB 18. Preferably, the signal level meter 20 is connected adjacent to the TV/STB 18 to provide an accurate reading of the signal level at the input to the TV/STB 18. This allows the installation process to account for signal losses caused by the coaxial cable and connectors between the antenna 10 and the TV/STB 18.

As shown in FIG. 2, the signal level meter 20 includes a number of RF preamplifiers 22, 25 to boost the antenna signal. A number of RF limiters 21, 24, 26 limit the amplitude of the signal and prevent signal distortion and potential damage to downstream components. An LTE filter 23 can be included to filter out interference for adjacent frequency bands commonly used for cellular communications (e.g., 4G LTE frequency bands). A balun 27 provides impedance matching. The signal level meter 20 can be powered by a battery, as shown in FIG. 2, or by other conventional means, such as a USB connection.

The signal level meter 20 is also equipped with a wireless communications module 29 for short-range data communications. For example, the Bluetooth protocol can be used for this purpose. Alternatively, wi-fi or other short-range wireless communication protocols could be employed.

The signal from the antenna 10 is demodulated by a tuner-demodulator 28 to output a signal for the TV/STB 18. For example, the tuner-demodulator 28 can be a MaxLinear MxL692 ATSC tuner-demodulator integrated circuit (MaxLinear, Inc., Carlsbad, Calif.) controlled by the wireless communications module 29. This tuner-demodulator 28 takes an RF input signal (ATSC) from 44 MHz-1006 MHz and can be used to selectably output either a replica of the antenna signal, or an MPEG transport stream in serial or parallel format to a conventional TV or STB 18. It also includes a broadband input filter, a channel filter, automatic gain control, and spectrum analyzer, and provides other functionality, including the ability to select channels and report signal strength. All of these features are under the control of commands relayed by the wireless communications module 29. For example, the I²C (Inter-Integrated Circuit) protocol can be employed to support communication of data and commands between the wireless communications module 29 and the tuner-demodulator 28. This tuner-demodulator 28 has the advantage of providing a quick RSSI (received signal strength indication) scan, and the ability for accuracy using a lock-based scan. In addition to measuring the signal level, the tuner-demodulator 28 provides positive ATSC signal confirmation, so that a true ATSC signal can be differentiated from noise or LTE signals. This provides an indication of signal quality (SNR), which tells the user whether the detected signal is of a good enough quality to be watchable. Optionally, the tuner-demodulator 28 could be used to demodulate signals in QAM (quadrature amplitude modulation) format, which is often used by cable television providers to encode and transmit digital cable channels.

The portable electronic device 30 can be a conventional smartphone, tablet computer or laptop computer. These devices 30 typically include a processor, memory and a display (e.g., a touchscreen), and are capable of running applications software, commonly referred to as “apps.” For example, an Apple iPhone or iPad, Android phone or tablet, or Chromebook laptop computer are suitable choices. The app used for communication with the signal level meter 20 should be written in the appropriate language based on the selected platform. The Android platform makes use of Java plus C/C++ to develop native apps. Apple's iOS platform relies on Objective-C and Swift as its native languages. C# is used by Microsoft's Windows Mobile platform to code its native apps.

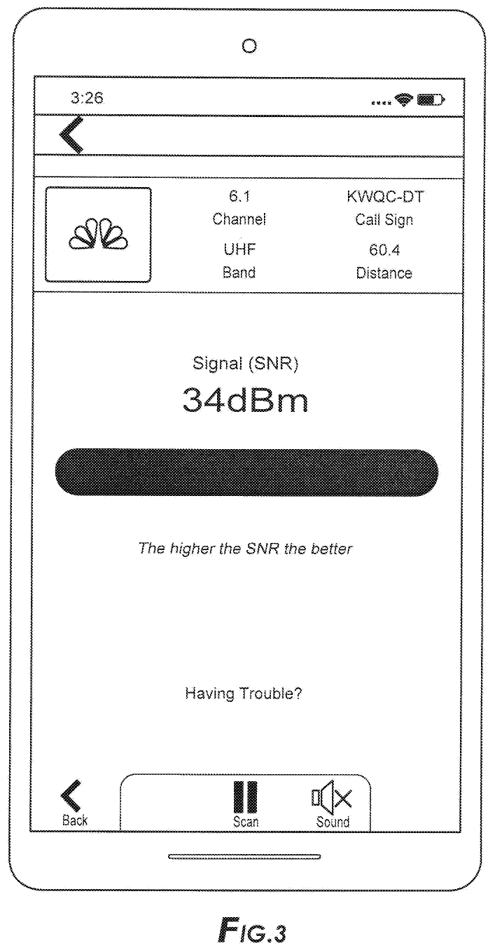

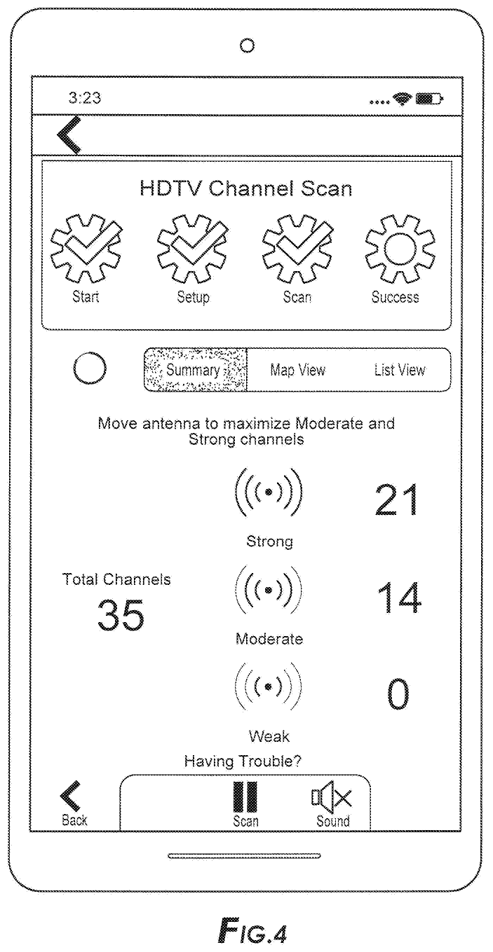

The app employs two-way communication between the portable electronic device 30 and the wireless communications module 29 to receive data from the signal level meter 20 and transmit commands to the signal level meter 20. The app displays signal strength data output by the signal level meter 20 to assist the user in optimizing installation of the antenna 10, as shown for example in FIG. 3. The user may view this signal strength data while making adjustments to the location and direction of the antenna 10. For example, the signal strength can be displayed as a numeric value or in a graphical form, such as a bar graph, pie chart, by color coding (e.g., red, yellow and green), or by an audible sound. The graphic user interface provided by the app may also display conventional controls (e.g., buttons, menu lists, etc.) enabling the user to view available signal sources 15 and control operation of the signal level meter 20, as shown for example in FIGS. 4-7. This user interface provided by the app also enables the user to remotely control operation of the signal level meter 20, including signal source selection (e.g., channel selection), amplifier gain and filter selection.

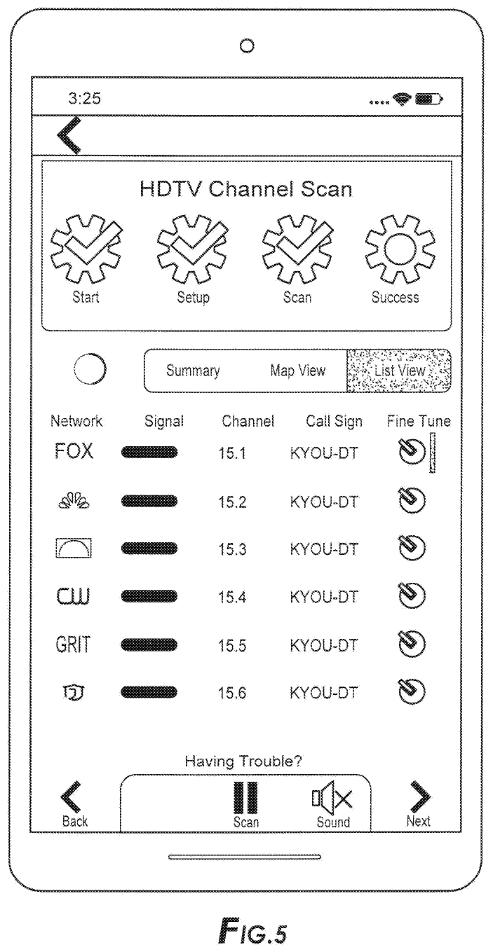

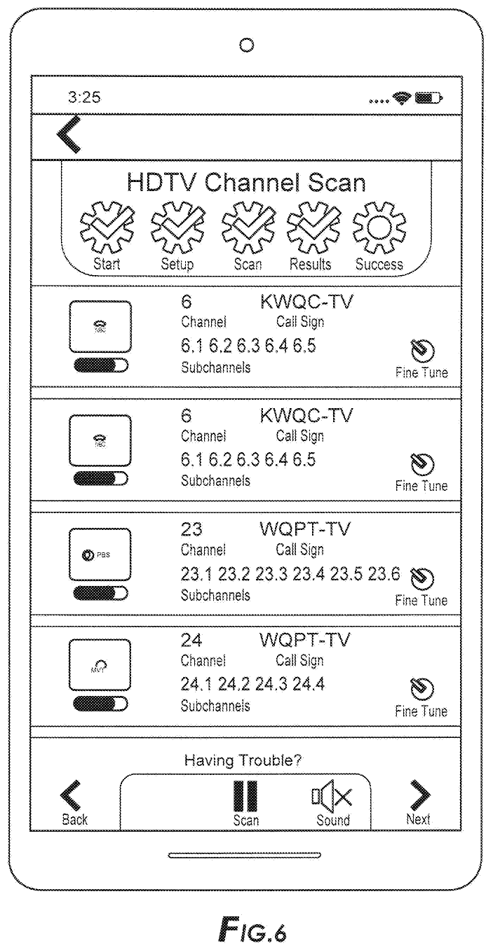

Optionally, the app may direct the tuner-demodulator 28 in the signal level meter 20 to scan over a range of channels or frequency bands to determine the available signal sources 15 and their respective signal strengths, as shown for example in FIGS. 4-6. Additional information regarding each signal source 15 (e.g., call sign, channel number and network) can be decoded from the received signal or accessed over the internet 40 from external databases (e.g., FCC databases 42). This additional information can also be displayed for the user by the app on the smartphone's display, as depicted in FIGS. 5-6.

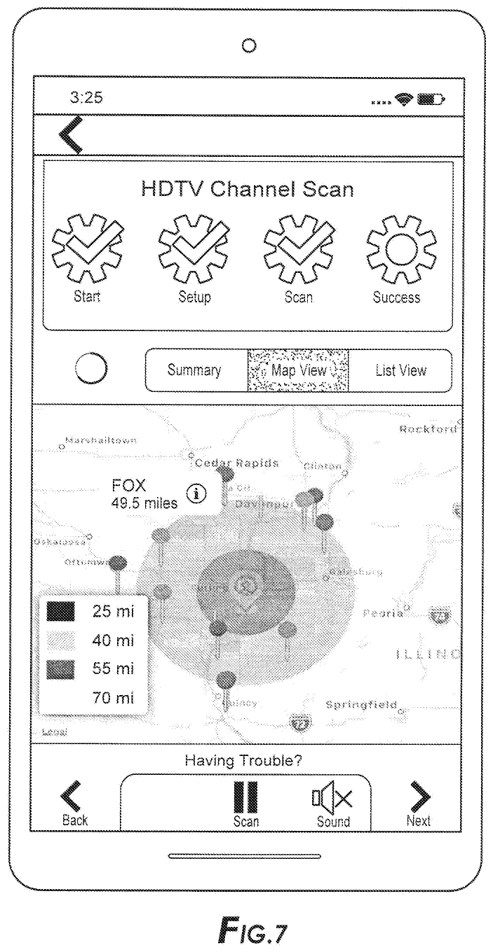

Many conventional smartphone include a global positioning system (GPS) and compass modules that enable the app to determine the location and bearing of the smartphone. The app can also access mapping information 44 (e.g., Google Maps or Apple Maps) via the internet 40 to generate and display a map of the current geographic area for the antenna 10 showing the locations and identifying information and signal strengths for the available signal sources 15. An example is shown in FIG. 7. Here again, the app can employ color coding of signal sources to indicate their respective signal strengths (e.g., red, yellow and green), or gray out weak signals.

In a typical installation, the antenna 10 is initially deployed or erected at a selected location remote from the TV/STB 18. For example, this could be on the roof of a structure or exterior of a vehicle housing the TV/STB 18. In the case of a directional antenna, it can be initially pointed in the general direction of a desired signal source 15. The signal level meter 20 is installed in the cable from the antenna 10 to the TV/STB 18. If necessary, the app is installed on the portable electronic device 30. The portable electronic device 30 is paired with the wireless communications module 29 of the signal level meter 20 to establish a communications link (e.g., via Bluetooth) between these devices 20, 30. The portable electronic device 30 may determine its present location by GPS. Optionally, it may also access the internet to download information regarding signal sources that are likely to be found based on its location, and map info for the vicinity of the antenna 10.

At this point, the user can employ the various controls provided by the app on the portable electronic device 30 to interactively obtain data and send commands to the signal level meter 20, as described above. For example, the signal level meter 20 can be used to measure the signal strength for a single desired signal source 15 or directed to scan for available signal sources 15. The resulting signal strength data is transmitted via Bluetooth to the portable electronic device 30 and displayed by the app. This allows the user to make adjustments to the position or location of the antenna 10 and observe the resulting effect on signal strength for each signal source 15.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. A system for assisting in installation of a remote antenna outputting an antenna signal to a television or set top box (TV/STB), said system comprising:
a signal level meter measuring the antenna signal input to the TV/STB, said signal level meter having:
(a) a wireless interface for external communication of data and commands; and
(b) a tuner-demodulator controlled by commands received via the wireless interface demodulating the antenna signal and providing adjustable gain to generate an output signal for the TV/STB, said tuner-demodulator also measuring and outputting signal strength via the wireless interface; and
applications software running on a portable electronic device transportable to the location of the antenna; said portable electronic device having a processor, display, and wireless interface for communication of data and commands with the signal level meter; said applications software and portable electronic device providing:
(a) a visual indication on the display of the signal strength received via the wireless interface from the tuner-demodulator; and
(b) a user interface enabling a user to remotely control operation of the signal level meter by commands communicated via the wireless interface.

2. The system of claim 1 wherein the user interface further comprises means for enabling the user to remotely control the gain of the tuner-demodulator via the wireless interface.

3. The system of claim 1 wherein the portable electronic device includes global positioning system (GPS) functionality for determining the location of the portable electronic device, and provides internet access; and wherein the applications software accesses an internet database to download identifying information regarding signal sources based on the location of the portable electronic device and displays identifying information and signal strength information for the signal sources.

4. The system of claim 1 wherein the tuner-demodulator decodes identifying information from the antenna signal regarding at least one signal source, and wherein the applications software generates a display of the identifying information and signal strength information for the signal sources.

5. The system of claim 4 wherein the tuner-demodulator scans a range of frequencies under the control of the applications software to identify a plurality of signal sources.

6. The system of claim 1 wherein the applications software displays a map of signal sources and their respective signal strengths.

7. The system of claim 1 wherein the signal level meter further comprises at least one filter selectable by the applications software for filtering the antenna signal.

8. The system of claim 1 wherein the signal level meter further comprises a preamplifier for the antenna signal having a gain controlled by the applications software.

9. A system for assisting in installation of a remote antenna outputting an antenna signal to a television or set top box (TV/STB), said system comprising:
a signal level meter measuring the antenna signal input to the TV/STB, said signal level meter having:
(a) a wireless interface for external communication of data and commands; and
(b) a tuner-demodulator controlled by commands received via the wireless interface demodulating the antenna signal and providing adjustable gain to generate an output signal for the TV/STB, said tuner-demodulator also measuring and outputting signal strength via the wireless interface; and
applications software running on a portable electronic device transportable to the location of the antenna; said portable electronic device having a processor, display, wireless interface for communication of data and commands with the signal level meter, global positioning system (GPS) functionality for determining the location of the portable electronic device, and providing internet access; said applications software and portable electronic device providing:
(a) a visual display of identifying information regarding signal sources downloaded from an internet database based on the location of the portable electronic device, and corresponding signal strength information for signal sources received via the wireless interface from the tuner-demodulator; and
(b) a user interface enabling a user to remotely control operation of the signal level meter by commands communicated via the wireless interface.

10. The system of claim 9 wherein the user interface further comprises means for enabling the user to remotely control the gain of the tuner-demodulator via the wireless interface.

11. The system of claim 9 wherein the applications software and portable electronic device display a map of signal sources and their respective signal strengths.

12. The system of claim 9 wherein the signal level meter further comprises at least one filter selectable by the applications software for filtering the antenna signal.

13. The system of claim 9 wherein the signal level meter further comprises a preamplifier for the antenna signal having a gain controlled by the applications software.

14. A system for assisting in installation of a remote antenna outputting an antenna signal to a television or set top box (TV/STB), said system comprising:
a signal level meter measuring the antenna signal input to the TV/STB, said signal level meter having:
(a) a wireless interface for external communication of data and commands; and
(b) a tuner-demodulator controlled by commands received via the wireless interface, demodulating the antenna signal with adjustable gain to generate an output signal for the TV/STB and decoding identifying information from the antenna signal regarding signal sources, said tuner-demodulator also scanning over a range of frequencies to measure and output signal strength information for signal sources via the wireless interface; and
applications software running on a portable electronic device transportable to the location of the antenna; said portable electronic device having a processor, display, wireless interface for communication of data and commands with the signal level meter, and global positioning system (GPS) functionality for determining the location of the portable electronic device; said applications software and portable electronic device providing:
(a) a visual display of identifying information and signal strength information for signal sources received via the wireless interface from the tuner-demodulator; and
(b) a user interface enabling a user to remotely control operation of the signal level meter by commands communicated via the wireless interface.

15. The system of claim 14 wherein the user interface further comprises means for enabling the user to remotely control the gain of the tuner-demodulator via the wireless interface.

16. The system of claim 14 wherein the applications software and portable electronic device display a map of signal sources and their respective signal strengths.

17. The system of claim 14 wherein the signal level meter further comprises at least one filter selectable by the applications software for filtering the antenna signal.

18. The system of claim 14 wherein the signal level meter further comprises a preamplifier for the antenna signal having a gain controlled by the applications software.
